(19) United States
(12) Patent Application Publication
(10) Pub. No.: US 2004/0151632 A1
(43) Pub. Date: Aug. 5, 2004

(54) Luminescence assays and assay readers

(76) Inventors: Robert Andrew Badley, Sharnbrook (GB); Michael Catt, Wellingborough (GB); Alan Thomson, Bedford (GB)

Correspondence Address: FOLEY HOAG, LLP, PATENT GROUP, WORLD TRADE CENTER WEST, 155 SEAPORT BLVD, BOSTON, MA, 02110, US

(21) Appl. No.: 10/609,014

(22) Filed: Jun. 27, 2003

(30) Foreign Application Priority Data
Aug. 27, 2002 (GB) 0219891.9
Jun. 27, 2002 (GB) 0214881.5

(51) Int. Cl. G01N 21/66

(52) U.S. Cl. 422/82.08; 436/172

(57) ABSTRACT

This invention relates to methods and apparatus for detecting the presence of analyte in a sample, in particular to luminescence-based methods for such detection.

### RELATED APPLICATIONS

This application claims the benefit of priority to Great Britain Patent Application serial number 0219891.9, filed Aug. 27, 2002 and Great Britain Patent Application serial number 0214881.5, filed Jun. 27, 2002, the contents of which are hereby incorporated by reference in their entireties.

### BACKGROUND OF THE INVENTION

The use of luminescence in diagnostic assay systems has led to improvements in both sensitivity and the ability to quantify analyte levels, compared to traditional color detection methods. A fluorescence-based system, for example, may employ a lamp to provide excitation light to excite a fluorescent label molecule and a detection system, typically a camera or photodiode, to quantify the emitted light from the fluorescent label. Very low levels of fluorescent label molecules may be detected in this way. Commonly in assay systems, fluorescent label molecules are attached to other molecules which take part in binding events involving analyte. This allows low levels of analyte to be detected and quantified.

A major drawback with the use of fluorescence-based assay systems is the high level of instrumentation required to detect and process the luminescent signal prior to its interpretation by the user. The provision of an excitation source, a photodetector and a processor results in bulky and/or expensive instruments.

Visually read qualitative assay systems incorporating colored labels such as gold sol and blue latex particles provide useful but limited sensitivity. This is primarily due to the inherent insensitivity of light absorption, which is how color is detected. Whilst this has allowed the development of rapid user-friendly assay systems for the assessment of analytes such as hCG (human chorionic gonadotrophin) in the urine of pregnant women, there is a need for more sensitive assays in order to detect other analytes in similar user-friendly formats. Furthermore, improvements in the sensitivity of hCG assays may have significant implications in the detection of pregnancy in an emergency room setting, where the detection of pregnancy before any outwardly visible signs may directly affect the treatment administered.

### SUMMARY OF THE INVENTION

The present invention features luminescence-based assays that provide a result which can be visually assessed by the user and which have significantly greater sensitivity than conventional visually read color-based assays, as well as assay readers for use with such methods.

In one aspect, the present invention provides an assay reader for determining the presence of a luminescent label in the capture zone of an assay device comprising: a positioning member to hold the assay device in a reading position; a light source which produces an excitation signal for exciting luminescent label in the capture zone when the assay member is in the reading position; and a viewing window for direct observation of the luminescent emission signal from the label in the capture zone. In certain embodiments, the light source may be contained in a housing, the housing further containing the assay device when in the reading position, the viewing window being positioned in the housing so as to provide for direct observation of the emission signal from label in the capture zone of the device. The wavelength of the excitation signal may in certain embodiments be different from the wavelength of the emission signal. For example, the wavelength of the excitation signal may be greater than the wavelength of the emission signal. In another example, the wavelength of the excitation signal may be less than the wavelength of the emission signal.

In any of the foregoing embodiments, a subject assay reader may comprise a filter which blocks the passage of the excitation signal and allows the passage of the emission signal through the viewing window. For example, the filter may be located on the window. In another embodiment, the filter may be located in the assay device.

In other embodiments, a subject assay reader may be adapted for determining the presence of a first and a second luminescent label in the capture zone, the reader comprising a first filter which blocks the passage of the first emission signal from the first label and a second filter which blocks passage of a second emission signal from a second luminescent label. In certain embodiments, the first and second filters can be exchanged between a first configuration, in which the first filter may be positioned at the viewing window and a second configuration, in which the second filter may be positioned at the viewing window. In another embodiment, the first filter may be positioned at a first viewing window and the second filter may be positioned at a second viewing window.

In other embodiments, a subject assay reader may comprise a first light source which produces a first excitation signal for exciting the first luminescent label and a second light source which produces a second excitation signal for exciting the second luminescent label. In certain embodiments, the first and second light sources may be exchanged between a first mode, in which the first excitation signal is produced without the second excitation signal, and a second mode, in which the second excitation signal is produced without the first excitation signal. The subject assay readers may be adapted to determine the presence of three or more labels in the capture zone.

In some embodiments, the window of a subject assay reader may comprise an aperture in the housing. In certain embodiments, the housing may define a recess and the window may comprise the mouth of the recess. In still other embodiments, the window may comprise a lens, which lens may be shaped to adapt the image in the window, or, may be shaped to magnify the image in the window. In embodiments, wherein the assay reader is to determine the presence of a first and a second luminescent label in the capture zone, emission from the first label may be adapted into a first shape and emission from the second label may be adapted into a second shape. The window in any of the embodiments of the invention may comprise a non-reflective surface.

The luminescent label determinable by any of the subject assay readers may be a fluorescent label. In such embodiments, the emission signal may be a fluorescent emission signal. In certain embodiments, the light source may be an ultra-violet light source. The excitation signal may be ultra-violet light in certain embodiments.

A battery may be connected to the light source in any of the embodiments of the subject assay readers. Further, the subject assay readers may comprise circuitry adapted to power the light source in the presence of liquid in the assay device. In certain embodiments, the circuitry may provide a fixed current from the battery. In other embodiments, a control indicator may be used to indicate sufficient battery power to generate the excitation signal. The control indicator may be an LED indicator on an outer surface of the reader, or may alternatively be an electro-chromic or thermo-chromic indicator on an outer surface of the reader. The control indicator may be a fluorescent dye which produces a control emission signal in response to the excitation signal.

In certain embodiments, the subject assay reader may be separable from the assay device. In still other embodiments, the reader and the assay device are non-separable. The assay device in certain embodiments may be a lateral flow immunoassay device, and in other embodiments, may be a homogenous assay device.

In another aspect, the present invention relates to an assay apparatus comprising any of the above-described assay readers and one or more assay devices. In certain embodiments, the one or more assay devices comprise a capture zone and one or more luminescent labels.

In still another aspect, the present invention relates to methods of determining the presence of a luminescent label in the capture zone of an assay device comprising exciting the label with an excitation signal of a first wavelength such that the excited label produces an emission signal of a second wavelength, and visually observing the emission signal. In certain embodiments, a subject method comprises filtering the excitation signal from the emission signal prior to observing the emission signal. In other embodiments, the label used in a subject method is selected from the group consisting of a fluorescent label immobilised in a polystyrene microsphere, a quantum dot and an up-converting phosphor containing ceramic microsphere.

In yet another aspect, the present invention relates to methods of determining the presence of an analyte in a sample comprising: providing an assay device which comprises a luminescent label and a capture zone, contacting the device with a sample suspected of containing an analyte such that the amount of label captured in the capture zone is altered in the presence relative to the absence of analyte in the sample, exciting the label captured in the capture zone with an excitation signal of a first wavelength such that the excited label produces an emission signal of a second wavelength, and visually observing the emission signal.

### BRIEF DESCRIPTION OF THE DRAWINGS

FIG. 1 shows a perspective view of an assay reader according to one embodiment of the invention with an assay device in the reading position.

FIG. 2 shows a cutaway perspective view of an assay reader according to one embodiment of the invention with an assay device in the reading position showing the housing interior.

FIG. 3 shows a plan view of the interior of the housing.

FIG. 4 shows an example of a circuit plan for an assay reader.

FIG. 5 shows an example of current regulating circuitry.

FIG. 6 contains Table 1, which shows results obtained using a model hCG lateral flow sandwich assay using fluorescent microspheres and read using a prototype visual reader.

FIG. 7 contains Table 2, which shows results obtained using a model strep A lateral flow sandwich assay using fluorescent microspheres and read using a prototype visual reader.

### DETAILED DESCRIPTION OF THE INVENTION

1. General

The invention features a rapid user-friendly assay format, that utilizes the inherent sensitivity of luminescence, to provide a result which can be visually assessed by the user and which has significantly greater sensitivity than conventional visually read color-based assays. The disclosed assay readers allow the direct observation of a luminescent signal on an assay device by the user and are therefore suitable for use in rapid user-friendly assay systems.

2. Definitions

For convenience, before further description of the present invention, certain terms employed in the specification, examples, and appended claims are collected here.

The singular forms “a”, “an”, and “the” include plural references unless the context clearly dictates otherwise.

The term “analyte” refers to any compound or molecule able to be measured by the device and method of the invention. The analyte may be present in any type of sample, for example, solubilized in a liquid sample, such as blood or urine, or present in or on a cell sample, such as a skin swab or throat swab, or derived or purified from a culture.

A “capture zone” is any region of an assay device in which the presence of luminescent label may be detected and/or measured to determine the presence of analyte in a sample. Thus in a lateral flow device, the capture zone may be part of a porous matrix which contains capture reagents for immobilising luminescent label. Such reagents may be comprised within one or more binding regions. Depending on the assay format, the amount of immobilised luminescent label in the capture zone may increase or decrease in the presence of analyte. For example, in a sandwich assay format, the amount of immobilised label will increase, while in a competition assay format, the amount of immobilised label will decrease. Alternatively, in a homogenous assay device, the capture zone may be any portion of an assay solution in which assay reagents bind to analyte to produce an increase or decrease in the amount of label molecule, which is available to luminesce in response to excitation. In some embodiments, the capture zone of a homogenous assay device may thus comprise the entire assay solution.

“Comprise” and “comprising” are used in the inclusive, open sense, meaning that additional elements may be included.

The term ‘emission signal” refers to electromagnetic radiation emitted when an atom in an excited higher energy state decays to a lower energy state.

The term “excitation signal” refers to the energy, for example, that from electromagnetic radiation, which causes an electron of an atom to move from a lower energy state into an “excited” higher energy state.

“Including” is used herein to mean “including but not limited to”. “Including” and “including but not limited to” are used interchangeably.

The term “label” refers to any atom, molecule or compound that can be detected or generates a signal.

A “light source” may be any lamp or light emitter which produces light of a wavelength suitable to excite the label. Conveniently the source may be an LED. In some embodiments, the light source is an ultra-violet light source, for example an ultra-violet LED such as the Roithner Lasertechnik RLT370-110 UV emitter or the Toyoda-Gosei E1L5M-3P0AP-02 UV emitter.

The term “luminescence” refers to any emission of light that does not derive energy from the temperature of an energy source (for example, a source of electromagnetic radiation, a chemical reaction, mechanical energy). In general, the source causes an electron of an atom to move from a lower energy state into an “excited” higher energy state; then the electron releases that energy in the form of emitted light when it falls back to a lower energy state. Such emission of light usually occurs in the visible or near-visible range of the electromagnetic spectrum. The term “luminescence” includes, but is not limited to, such light emission phenomena such as phosphorescence, fluorescence, bioluminescence, radiluminescence, electro-luminescence, and thermo-luminescence.

The term “luminescent label” refers to a label that generates a luminescent signal, e.g. an emission of light that does not derive energy from the temperature of the emitting source. The luminescent label may be, for example, a fluorescent molecule, a phosphorescent molecule, a radiluminescent molecule, a luminescent chelate, a phosphor or phosphor-containing compound, or a quantum dot.

A “positioning member” may be any feature, which holds the device in place in or on the reader. Many such features are known in the art. For example, the member may be a clip, or a recess/protrusion, which engages a corresponding protrusion/recess on the assay device.

A “sample” includes material obtained from a subject. For example, samples may be obtained from a human or animal subject (including saliva, urine, blood), a plant, a cell culture or an environmental location, such as a water or an air sample. Sample also includes materials that have been processed or mixed with other materials. For example, a blood sample may be processed to obtain serum, red blood cells, etc., each of which may be considered a sample.

“Small molecule” refers to a composition that has a molecular weight of less than about 1000 daltons, such as organic (carbon-containing) or inorganic molecules.

A suitable viewing “window” may be any opening or open region which allows the operator to directly observe the emission signal from the capture zone of the assay device.

3. Assay Readers

One aspect of the invention provides an assay reader for determining the presence of a luminescent label in the capture zone of an assay device comprising,

a positioning member to hold the assay device in a reading position,

a light source which produces an excitation signal for exciting luminescent label in the capture zone when the assay member is in the reading position, and;

a viewing window for direct observation of the luminescent emission signal from the label in the capture zone.

In certain embodiments, the luminescent label is a fluorescent label and the emission signal is a fluorescent emission signal. Exemplary fluorescent labels include, but are not limited to fluorescein and fluorescein deriviatives, rhodamine and rhodamine derivatives, Texas Red, Cy2, Cy3, Cy5, VECTOR Red, ELF.TM. (Enzyme-Labeled Fluorescence), Cy0, Cy0.5, Cy1, Cy1.5, Cy3, Cy3.5, Cy5, Cy7, FluorX, Calcein, Calcein-AM, CRYPTOFLUOR.TM.'S, Orange (42 kDa), Tangerine (35 kDa), Gold (31 kDa), Red (42 kDa), Crimson (40 kDa), BHMP, BHDMAP, Br-Oregon, Lucifer Yellow, Alexa dye family, N-[6-(7-nitrobenz-2-oxa-1,3-diazol-4-yl)amino]caproyl] (NBD), BODIPY.TM., boron dipyrromethene difluoride, Oregon Green, MITOTRACKER.TM. Red, DiOC.sub.7 (3), DiIC.sub.18, Phycoerythrin, Phycobiliproteins BPE (240 kDa) RPE (240 kDa) CPC (264 kDa) APC (104 kDa), Spectrum Blue, Spectrum Aqua, Spectrum Green, Spectrum Gold, Spectrum Orange, Spectrum Red, NADH, NADPH, FAD, Infra-Red (IR) Dyes, Cyclic GDP-Ribose (cGDPR), Calcofluor White, Lissamine, Umbelliferone, Tyrosine and Tryptophan. A wide variety of other fluorescent probes are available from and/or extensively described in the Handbook of Fluorescent Probes and Research Products 9^{th} Ed. (2002) (Molecular Probes, Eugene, Oreg.), as well as many other manufacturers.

In other embodiments, the luminescent label comprises a chelate, such as, for example, a lanthanide chelate such as europium (III), terbium (III) and samarium (III) beta-diketonates and beta-diketones.

Other suitable labels include, but are not limited to, quantum dots and up-converting phosphor containing ceramic particles.

The light source may be contained in a housing, the housing further containing the assay device when in the reading position,

the viewing window being positioned in the housing so as to provide for direct observation of the emission signal from label in the capture zone of the device.

The window may, for example, comprise an aperture or port in the housing of the reader or in other embodiments, the housing may define a recess which accommodates the assay device in the reading position, the window comprising the mouth of the recess.

Preferably, the wavelength of the excitation signal is different from the wavelength of the emission signal, for example, the wavelength of the excitation signal may be greater than the wavelength of the emission signal, or the wavelength of the excitation signal may be less than the wavelength of the emission signal.

For labels comprising beta-diketones of europium III (as used in DELFIA™ system from PerkinElmer Life Sciences), an excitation signal of 350-370 nm may be used to elicit an emission signal of 612 nm.

For labels comprising fluorescein (Molecular Probes), an excitation signal of 490 nm may be used to elicit an emission signal of 540 nm.

For labels comprising up-converting phosphor (Niedbala et al Anal. Biochem. 293 22-30 (2001); UPlink system, Orasure (Pennsylvania)), an excitation signal of about 980 nm may be used to elicit an emission signal of 475 or 550 nm.

Label in the capture zone may be confined to one or more discrete binding regions. These binding regions may, for example, take the form of a test line and a control line. The presence of label in the control line indicates that the test is working correctly and the presence of label in the test line indicates that there is analyte in the sample.

Two or more discrete binding regions may be observed through a single viewing window or through separate multiple viewing windows.

A reader may comprise a filter to block the passage of the excitation signal through the viewing window. This prevents visual observation of the emission signal being obscured or swamped by the excitation signal.

Suitable filters include dichroic filters (available, for example, from Optical Coating Laboratory Inc, Santa Rosa, Calif.) or band pass filters (available, for example, from Edmund Optics, Barrington N.J.). In some embodiments, preferred filters may have UV protective properties.

The filter may be located at the viewing window or elsewhere in the reader. In some embodiments, it may be located in the assay device. In such embodiments, the assay device in the reading position may be located between the viewing window and the light source, such that the filter in the device blocks the passage of the excitation signal from the light source to the viewing window.

An assay reader as described herein may be used for determining the presence of a first and a second luminescent label in the capture zone. This may be useful, for example where the first label produces a control signal and the second label produces a signal indicative of the presence of analyte. Alternatively, the presence of two or more different analytes may be determined using the same assay device, a different label producing a signal indicative of each analyte. The reader may also be used to determine the presence of more than two, for example three, four, five, six or more than six labels in the capture zone.

This may be achieved in a number of ways. For example, a reader may comprise a first filter which blocks the passage of the first emission signal, which may for example be a control signal, from the first label and a second filter which blocks passage of a second emission signal from a second luminescent label.

The first and second filters may be exchanged between a first configuration, in which the first filter is positioned at the viewing window and a second configuration, in which the second filter is positioned at the viewing window. This allows the operator to change the filter to view the different emission signals in turn (i.e. sequentially).

Alternatively, the first filter may be positioned at a first viewing window and the second filter may be positioned at a second viewing window. This allows the operator to change the filter to view the different emission signals simultaneously using separate viewing windows.

In another approach, a reader may comprise a first light source, which produces a first excitation signal for exciting the first luminescent label and a second light source which produces a second excitation signal for exciting the second luminescent label.

The first and second light sources may be exchanged between a first mode, in which the first excitation signal is produced without the second excitation signal, and a second mode, in which the second excitation signal is produced without the first excitation signal. This allows the operator to observe the first emission signal by operating only the first light source and then to observe the second emission signal by operating only the second light source.

To determine the presence of increased numbers of labels, the number of filters and/or light sources described above may be increased accordingly.

An assay reader may comprise a light guide which channels the excitation signal from the light source as required to different regions of the capture zone, for example to one or more binding regions such as test and control lines. For example light from a single light source may be split and be directed to two or more different regions in controlled proportions. This may increase the strength of the emission signal and improve the accuracy of the results.

The viewing window may comprise a lens to manipulate the emission signal for observation, i.e. the lens may be shaped so as to adapt the image in the viewing window, for example, it may magnify the image in the window.

The properties of the lens depend on the composition, curvature and design of the lens. A lens may also be used in conjunction with apertures of particular shapes.

In embodiments in which the assay reader is used to determine the presence of a first and a second luminescent label in the capture zone, the emission from the first label may be adapted into a first shape and emission from the second label may be adapted into a second shape. This facilitates the distinction of the two signals, one of which may be a control and the other a sample signal, by the operator.

The window may comprise a non-reflective surface to prevent reflected ambient light from impeding observation of the emission signal. The window may also comprise a screen, which allows passage of the emission signal but prevents the entry of external ambient light into the reader.

The light source may be powered by a power source such as a battery connected thereto. Suitable batteries include lithium and alkaline batteries. The reader may comprise circuitry, which is adapted to power the light source in the presence of liquid in the assay device. Suitable circuitry may include electrodes to contact the assay device in the reading position.

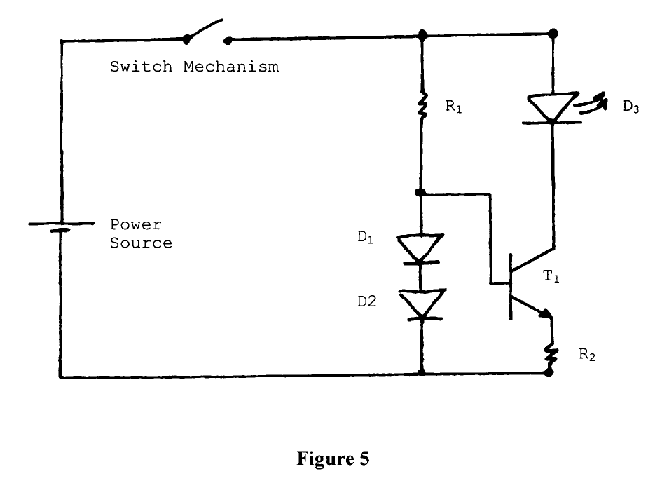

The reader may also comprise circuitry, which provides a fixed current from the battery. This prevents inaccurate or false readings caused by low battery charge. An example of suitable circuitry is shown in FIG. 5. In this example, two diodes (D1, D2) are fed from resistor (R1) and develop a constant voltage of 2V (approx.) regardless of battery voltage. This voltage is connected to the base of transistor (T1). The constant base emitter drop of 0.7V ensures that a fixed voltage of 1.3V (approx.) appears across resistor (R2). This sets the current flowing out of the emitter of the transistor (T1) at a fixed level. The current flowing into the connector is approximately equal to the emitter current, and hence the current through the light emitting diode (D3) is fixed at this level.

To ensure that the reader is working properly before taking a reading, an assay reader may comprise a control indicator to indicate the generation of the excitation signal.

Suitable control indicators may include an LED, electro-chromic or thermo-chromic indicator. Such an indicator may be positioned on an outer surface of the reader or within the housing such that the indicator is visible through a control window. Alternatively, fluorescent dye may be disposed within the housing to produce a control emission signal in response to the excitation signal.

The reader and the assay device may be separable components. The assay device for example may be disposable after a single use while the reader may be re-usable using a fresh assay device for each reading.

Alternatively, the reader and the assay device may be non-separable and both elements may be disposable after a single use.

Preferably, the assay reader has dimensions suitable for hand-held operation and convenient storage.

An assay device suitable for use in combination with a reader as described herein may include any device, which produces a luminescent, preferably fluorescent, signal which is modulated (i.e. increased or decreased) by the presence of analyte. Preferably, a signal is produced or increased in the presence of analyte, for example through a sandwich assay format, although other arrangements are also possible, for example a competition assay format. The principles and practice of fluorescence-based immunoassays is well known in the art and various examples are commercially available, including Ramp™ (Response Biomedical, Burnaby Canada) and Biosite Triage™ (Biosite, San Diego Calif.).

Suitable assay devices for use with a reader of the invention include lateral flow immunoassay devices and homogenous assay devices.

In a lateral flow immunoassay in the ‘sandwich’ format, the presence of sufficient analyte in a sample will cause the formation of a ‘sandwich’ interaction at the capture zone in the lateral flow assay, whereby the polystyrene microspheres loaded with a fluorescent dye of choice become immobilised. Therefore, when the assay device held in the reading position and the light source is switched on, visible fluorescence is emitted. When sufficient particles are bound, the emitted light will be visible to the naked eye.

In a homogeneous assay device, sample is added directly to reagents, which include a luminescent label in a reaction chamber. The presence of analyte in the sample increases or reduces the amount of label in the chamber, which is able to luminescence in response to excitation. Examples of homogenous assay systems include molecular beacons (Tyagi & Kramer (1996) Nat. Biotechnol. 14 303-318).

Other assays devices that may be used in the readers of the invention include, but are not limited to, flow-through devices, and.

In a flow-through assay, one reagent (usually an immunoreagent) is immobilized to a defined area on a membrane surface. This membrane is then overlaid on an absorbent layer that acts as a reservoir to pump sample volume through the device. Following immobilization, the remainder of the protein-binding sites on the membrane are blocked to minimize nonspecific interactions. When the assay is used, a sample containing analyte is added to the membrane and filters through the matrix, allowing the analyte to bind to the immobilized antibody. In an optional second step (in embodiments wherein the first reactant is an immunoreactant), a tagged secondary antibody (an enzyme conjugate, an antibody coupled to a colored latex particle, or an antibody incorporated into a colored colloid) may be added or released that reacts with captured analyte to complete the sandwich. Alternatively, the secondary antibody can be mixed with the sample and added in a single step. If analyte is present, a colored spot develops on the surface of the membrane.

Another aspect of the invention provides an assay apparatus comprising an assay reader as described above and one or more assay devices.

As described above, suitable assay devices produce a luminescent, preferably fluorescent signal, which is modulated (i.e. increased or decreased) by the presence of analyte. Such devices are well known in the art.

Suitable assay devices may comprise a capture zone, which contains capture reagents such as antibody molecules, antigens, nucleic acids, lectins, and enzymes suitable for capturing a label. A device may also incorporate one or more luminescent labels suitable for capture in the capture zone, the extent of capture being determined by the presence of analyte. Suitable labels include fluorescent labels immobilised in polysterene microspheres. Microspheres may be coated with immunoglobulins to allow capture in the capture zone.

The microspheres of the present invention may be comprised of any material to which labels or other capture agents may be immobilized, linked, encapsulated, or entrapped. Exemplary microspheres include, but are not limited to, those comprised of: polysterene, polystyrene, polystyrene, polymethylmethacrylate, polyethylene glycol, polypropylene, polycarbonate, polyethylene, polyurethane, polypropylene glycol, expanded polytetrafluoroethylenes, fluorinated ethylene propylene, polyvinylalcohol, polycarbonate, polylactides, polyglycolids, polycaprolactides, polyarylates, polyanhydrides, and polyphosphoesters. Microspheres may comprise a controlled-release polymer.

4. Assay Methods

Another aspect of the invention provides a method of determining the presence of a luminescent label in the capture zone of an assay device comprising,

exciting the label with an excitation signal of a first wavelength such that the excited label produces an emission signal of a second wavelength, and;

visually observing the emission signal.

A method may further comprise filtering the excitation signal from the emission signal prior to observing the emission signal.

Another aspect of the invention provides a method of determining the presence of an analyte in a sample comprising;

providing an assay device which comprises a luminescent label and a capture zone,

contacting the device with a sample suspected of containing an analyte;

such that the amount of label captured in the capture zone is altered in the presence of the analyte in the sample relative to the absence of analyte in the sample,

exciting label captured in the capture zone with an excitation signal of a first wavelength such that the excited label produces an emission signal of a second wavelength, and;

visually observing the emission signal.

The methods of the invention may be adapted to detect any analyte, for example, by choice of suitable capture agents for the analyte that is to be detected. Exemplary analytes detectable by the methods of the invention include, but are not limited to: hormones or hormone metabolites or hormone precursors, such as hCG (human chorionic gonadotrophin), cholesterol, insulin, luteinizing hormone, estrone-3-glucuronide, follicle-stimulating hormone (FSH); polypeptides or proteins such as alanine aminotransferase, hemoglobin, microalbumin, urinary albumin, urine catalase, prothrombin; small molecules such as amine, cholesterol, nitrites, amphetamines, morphine, nicotine or nicotine metabolites, ketones, alcohols, ascorbic acid, phencyclidine, lactic acid, sugars (e.g. glucose), cannabinoids (THC), methampetamine and other amphetamines, cocaine and cocaine metabolites, fructosamine, creatinine, triglycerides; antigens such as bladder tumor associated antigen, bacterial antigens such as Streptococcus A specific carbohydrate antigen, Helicobater pylori antigens, Clostridium difficile toxin A, Chlamydia trachomatis antigen, viral antigens such as influenza A, A/B or B; antibodies, such as HIV antibodies, infectious mononucleosis antibodies, influenza A, A/B or B antibodies, Lyme disease antibodies (Borelia Burgdorferi); and other molecules and ions, such bilirubin, urobilin, urobilinogen, nucleic acids, and hydrogen ions (pH).

### EXEMPLIFICATION

The invention having been generally described, may be more readily understood by reference to the following examples, which are included merely for purposes of illustration of certain aspects and embodiments of the present invention, and are not intended to limit the invention in any way.

Sandwich lateral flow assays were performed as described in EPO29114 using polystyrene microspheres (obtained from Duke Scientific Corporation, Palo Alto), inside which a fluorescent dye was immobilised. This dye is proprietary to Duke, but is based upon chelates of beta-diketones and the lanthanide metal ion europium III. Other lanthanide metal ions such as terbium III, samarium III and dysprosium III may also be employed. The betadiketones are selected to allow for maximal excitation at about 350 nm. Emission is dictated by the europium ion, and is maximal at about 612 nm.

### Example 1

### Preparation of Microspheres

1 ml of 0.15% solids (w/v) polystyrene microspheres coated with antibody was prepared according to the following protocol.

Stock antibody, either Unipath mouse monoclonal 3299:4 anti-alpha hCG (human chorionic gonadotrophin—the hormone whose presence indicates that a woman is pregnant) or rabbit polyclonal anti-Streptococcus A (Biospacific), was diluted to the required working concentration in 10 mM disodium tetra borate buffer, pH 8.6, with 0.1% sodium azide (w/v) as preservative. For the anti-hCG antibody, this dilution was 100-120 μg/ml, and for the anti-Streptococcus A antibody, 50-70 μg/ml.

75 μl of stock polystyrene microspheres (at 2% solids w/v) were placed in the bottom of a round-bottomed microfuge tube (2 ml size). For the hCG assay, the microspheres were 190 nm in size with europium III chelates incorporated at 10% (w/w), and for the Streptococcus A assay, the microspheres were 400 nm in size with europium III chelates incorporated at 10% (w/w). The tube (containing the microspheres) was placed on a vortex mixer, low setting, and mixed gently.

While the microspheres were mixing, 925 μl of antibody solution was slowly added, and the microspheres/antibody mixture was kept mixing for at least 10 seconds after all of the antibody was added.

The microspheres/antibody mixture was then probe-sonicated as follows: the cleaned tip of a probe sonicator (MSE Soniprep 150) was placed into the microfuge tube to a depth of two thirds of the liquid. The probe sonicator was turned on and set to 6 micron amplitude for about 10 to 15 seconds, ensuring that the microspheres/antibody mixture was not frothing.

The tubes were then placed on an end-over mixer and placed in a subdued-lighting environment to incubate for 1 hour at room temperature. This ensures full passive coating of the microspheres with antibody. 15 μl of 200 mg/ml BSA solution was then added to the microspheres/antibody mixture, and mixing was continued for a further 30 minutes at room temperature using the end-over mixer, again in subdued lighting.

The tubes were then removed from the end-over mixer and centrifuged at 13,000 rpm (MSE Micro Centaur) for 10 minutes (400 nm-microsphere size) or 20 minutes (190 nm-microsphere size). The supernatant was discarded and the microsphere pellet resuspended with 1 ml of 10 mM disodium tetra borate (pH 8.6 with 0.1% sodium azide (w/v) as preservative) using pipetting action/sonication bath (Grant XB2 Ultrasonic Bath) and vortexing. The microsphere suspension was then probe-sonicated again as above.

The microfuge tubes were then centrifuged again as above. The supernatant was discarded and the microsphere pellet resuspended using pipetting action/sonication bath and vortexing with 1 ml storage buffer: 20% sucrose, 6.5% B SA in 10 mM disodium tetraborate, (pH 8.6 with 0.1% sodium azide (w/v) as preservative). The microsphere suspension was sonicated again as above and then stored at 4° C. until required for use.

### Example 2

### Assay Reader

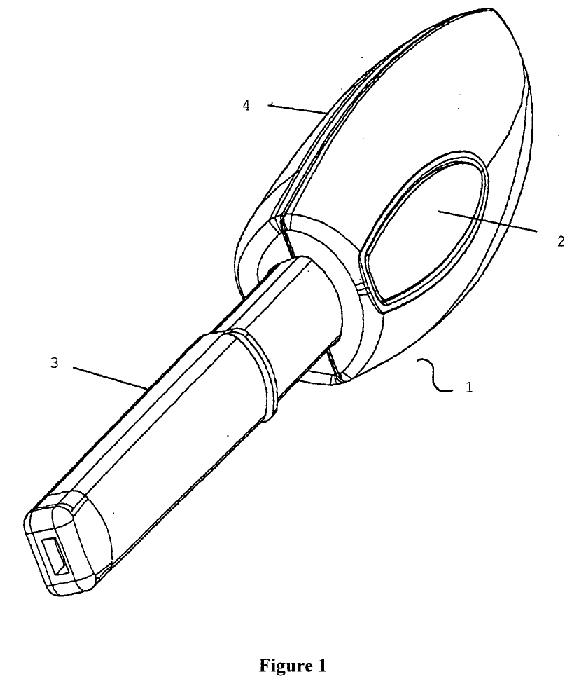

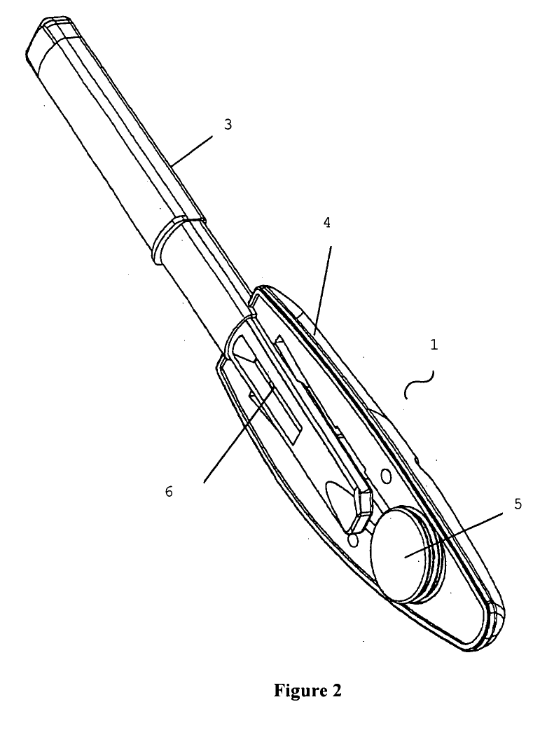

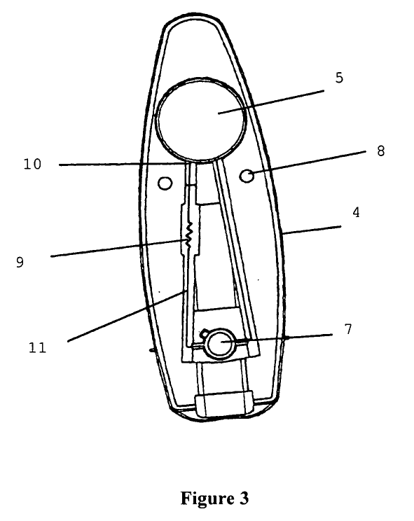

A prototype assay reader (1) was made as shown in FIGS. 1 to 3 and as follows:

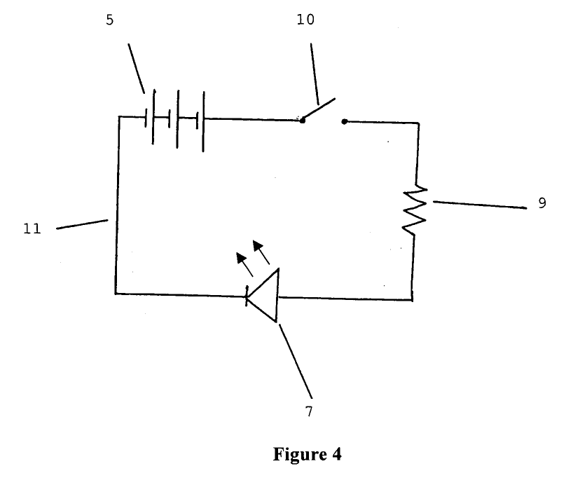

A Roithner Lasertechnik RL T370-110 UV emitter (7), a 330-Ohm resistor (9), a switching mechanism (10), and three lithium-cell batteries (Panasonic CR1818 3V) (5) were assembled and connected with wiring (11) according to the circuit diagram shown in FIG. 4, and housed in a plastic casing (4) suitable for holding the plastic lateral flow assay carriers (3) employed in the experimental work. Screw holes (8) for assembly of the casing (4) are shown in FIGS. 1 to 3.

The plastic casing (4) had a viewing window (2), which was covered with ultra-violet protective (supplied by Upland, Calif.) as commonly used in ultra-violet radiation blocking spectacles. When the plastic lateral flow assay carrier (3) was inserted into the prototype assay reader (1), a switch (10) was activated and the circuit completed.

Due to the design of the reader, the UV emitter (7) was positioned such that any immobilised microspheres (6) in the lateral flow assay, when assembled into the carrier (3), were directly aligned with the UV emitter (7). Therefore the fluorescent dye in the immobilised microspheres was excited, and when sufficient microspheres were immobilised the visible fluorescence could be observed through the UV-protected window (2).

### Example 3

### hCG Immunoassay

A model hCG lateral flow sandwich assay was set up. Liquid-conducting material, in this case nitrocellulose (Schliecher & Schuell, Unipath Code 500213) with a restricted zone of immobilised protein, in this case Unipath mouse monoclonal 3468:2 anti-beta hCG antibody, was prepared as detailed in EP0291194.

The nitrocellulose membrane was cut into strips 6 mm wide and 45 mm in length, the immobilised antibody being a 1 mm wide band at a distance of 10 mm from the end of the strip. These strips were assembled onto rigs such that the immobilised band of antibody was 10 mm from the bottom of each strip when held in a vertical position. Some absorbent material, such as Schliecher & Schuell gel blotting paper, was held in place at the top of each strip to absorb excess liquid. At the base of each strip was applied a mixture of 2.5 μl of the anti-alpha hCG coated fluorescently-dyed polystyrene microspheres (at 0.15% solds w/v in storage buffer) and 25 μl of hCG solution: hCG from Sigma, dissolved in phosphate buffered saline, pH 7.4, with 0.1% ovalbumin (Sigma) and 0.1% sodium azide as preservative) and calibrated using an AutoDELFIA assay for hCG.

When the microspheres/hCG solution was taken up by the nitrocellulose, a further 25 μl of hCG solution was added to the base of each strip. When all of the liquid was taken up, the nitrocellulose was removed from the rig, assembled into plastic carriers and read using the prototype assay reader.

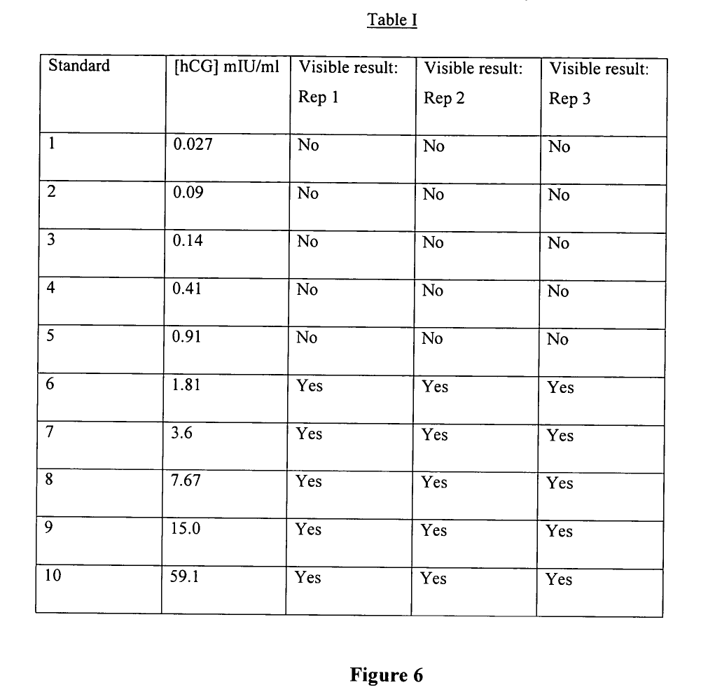

The results obtained from this experiment are shown in Table 1 (FIG. 6). As can be seen, levels of hCG as low as 1.81 mIU/ml can be detected visually using a lateral flow assay with fluorescent microspheres and the prototype reader.

This compares favourably with commercially available hCG lateral flow sandwich assays, such as the Clear Blue Easy™ (Unipath Ltd.) pregnancy test kit, with a lower detection limit of 50 mIU/ml, and the First Response Early Result™ (Carter-Wallace Inc) pregnancy test kit, which has a similar detection limit of about 50 mIU/ml.

### Example 4

### Streptococcus A Immunoassay

A standard immunoassay for Streptococcus A specific antigen would normally begin by performing an extraction procedure on a throat swab sample to release the Group A specific carbohydrate antigen from the peptidoglycan cell wall of the bacteria. This extraction procedure can be performed by placing the throat swabs into a 1:1 mixture of 1M acetic acid and 1M sodium nitrite (320 μl total volume). Mixing these two chemicals produces nitrous acid (an instable acid) which cleaves the Streptococcus A specific antigen from the bacterial cell wall. After about 2 minutes, 160 μl of a neutralising reagent, typically 1.6M Tris Base, can be added and a lateral flow assay performed on the neutralised cell extract.

A model assay system for the detection of Streptococcus A specific antigen was performed by substituting 20 μl volumes of standards of the purified Streptococcus A specific carbohydrate antigen for the throat swab, and carrying out the rest of the procedure (to mimic the real assay). The standards (Unipath, in-house) were prepared to give antigen levels equivalent to known numbers of cells in a suspension (cfu or colony forming units per ml).

Liquid-conducting material, in this case nitrocellulose (Schliecher & Schuell, Unipath Code 500226) with a restricted zone of immobilised protein, in this case rabbit polyclonal G47010145 anti-Strep. A antibody (BiosPacific), was prepared as detailed in EP0291194.

The nitrocellulose membrane was cut into strips 6 mm wide and 45 mm in length, the immobilised antibody being a 1 mm wide band at a distance of 10 mm from the end of the strip. These strips were assembled onto rigs such that the immobilised band of antibody was 10 mm from the bottom of each strip when held in a vertical position. Some absorbent material, such as Schliecher & Schuell gel blotting paper, was held in place at the top of each strip to absorb excess liquid. At the base of each strip was applied a mixture of 2.5 μl of anti-Strep. A antibody coated fluorescently-dyed polystyrene microspheres (at 0.075% solids w/v in storage buffer) and 25 μl of the neutralised cell extract. When the microspheres/cell extract solution was taken up by the nitrocellulose, a further 25 μl of cell extract solution was added to the base of each strip. When all of the liquid was taken up, the nitrocellulose was removed from the rig, assembled into plastic carriers and read using the prototype assay reader.

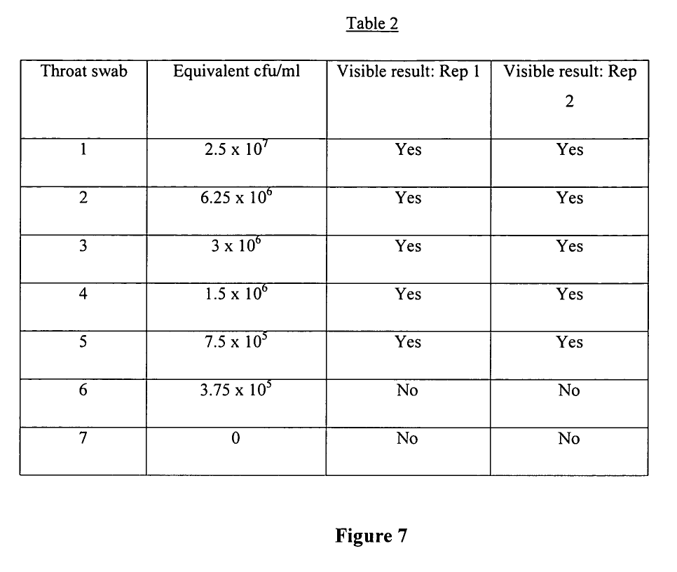

The results from this experiment are shown in Table 2 (FIG. 7).

As can be seen, the lowest detectable level of Streptococcus A specific antigen was that present in standard antigen preparation 5. This is equivalent to the amount of antigen one would expect to detect from 20 μl of a 7.5×10⁵ cfu/ml cell suspension. As only 20 μl of standard was used in the experiment, then the test has detected the equivalent of 1.5×10⁴ cfu.

This compares favourably with commercially available lateral flow assays for Streptococcus A based on the detection of the carbohydrate antigen. QuickVue Flex™ lateral flow Strep. A test (Quidel, San Diego, Calif.) detects about 5×10⁵ cfu or Streptococcus A organisms from a throat swab and Strep. A OIA MAX™ optical immunoassay ThermoBiostar, Boulder, Colo.) detects 1.2×10⁴ cfu from a throat swab—although this is not a lateral flow system, this is most sensitive immunoassay commercially available for the detection of Streptococcus A.

The prototype assay reader system allows for a 30-fold improvement over other lateral flow devices in the detection of Streptococcus A through the presence of the carbohydrate antigen.

### EQUIVALENTS

The present invention provides in part luminescence-based assay methods that provide a result which can be visually assessed by the user, as well as assay readers for use with such methods. While specific embodiments of the subject invention have been discussed, the above specification is illustrative and not restrictive. Many variations of the invention will become apparent to those skilled in the art upon review of this specification. The appendant claims are not intended to claim all such embodiments and variations, and the full scope of the invention should be determined by reference to the claims, along with their full scope of equivalents, and the specification, along with such variations.

All publications and patents mentioned herein are hereby incorporated by reference in their entireties as if each individual publication or patent was specifically and individually indicated to be incorporated by reference. In case of conflict, the present application, including any definitions herein, will control.

We claim:

1. An assay reader for determining the presence of a luminescent label in the capture zone of an assay device comprising:
a positioning member to hold the assay device in a reading position;
a light source which produces light at an appropriate wavelength to excite the luminescent label in said capture zone when said assay member is in the reading position; and
a viewing window for direct observation of the luminescent emission signal from said label in said capture zone.

2. An assay reader according to claim 1 wherein said light source is contained in a housing, the housing further containing the assay device when in the reading position, the viewing window being positioned in the housing so as to provide for direct observation of the emission signal from label in the capture zone of the device.

3. An assay reader according to claim 1, wherein the wavelength of the excitation signal is different from the wavelength of the emission signal.

4. An assay reader according to claim 3, wherein the wavelength of the excitation signal is greater than the wavelength of the emission signal.

5. An assay reader according to claim 3, wherein the wavelength of the excitation signal is less than the wavelength of the emission signal.

6. An assay reader according to claim 3 comprising a filter which blocks the passage of the excitation signal and allows the passage of the emission signal through the viewing window.

7. An assay reader according to claim 6, wherein said filter is located on said window.

8. An assay reader according to claim 7, wherein said filter is located in said assay device.

9. An assay reader according to claim 1 for determining the presence of a first and a second luminescent label in said capture zone, said reader comprising a first filter which blocks the passage of the first emission signal from the first label and a second filter which blocks passage of a second emission signal from a second luminescent label.

10. A assay reader according to claim 9, wherein the first and second filters can be exchanged between a first configuration, in which the first filter is positioned at said viewing window and a second configuration, in which the second filter is positioned at said viewing window.

11. An assay reader according to claim 9, wherein the first filter is positioned at a first viewing window and the second filter is positioned at a second viewing window.

12. An assay reader according to claim 1 for determining the presence of a first and a second luminescent label in said capture zone, said reader comprising a first light source which produces a first excitation signal for exciting the first luminescent label and a second light source which produces a second excitation signal for exciting the second luminescent label.

13. A assay reader according to claim 12, wherein the first and second light sources can be exchanged between a first mode, in which the first excitation signal is produced without the second excitation signal, and a second mode, in which the second excitation signal is produced without the first excitation signal.

14. An assay reader according to claim 9 adapted to determine the presence of three or more labels in the capture zone.

15. An assay reader according to claim 2, wherein said window comprises an aperture in said housing.

16. An assay reader according to claim 2, wherein said housing defines a recess and said window comprises the mouth of the recess.

17. An assay reader according to claim 1, wherein said window comprises a lens.

18. An assay reader according to claim 17, wherein said lens is shaped to adapt the image in said window.

19. An assay reader according to claim 18, wherein said lens is shaped to magnify the image in said window.

20. An assay reader according to claim 18 for determining the presence of a first and a second luminescent label in said capture zone, wherein emission from the first label is adapted into a first shape and emission from the second label is adapted into a second shape.

21. An assay reader according to claim 1, wherein said window comprises a non-reflective surface.

22. An assay reader according to claim 1, wherein said luminescent label is a fluoresent label and said emission signal is a fluorescent emission signal.

23. An assay reader according to claim 1, wherein said light source is an ultra-violet light source and said excitation signal is ultra-violet light.

24. An assay reader according to claim 1, comprising a battery connected to said light source.

25. An assay reader according to claim 1, comprising circuitry adapted to power the light source in the presence of liquid in said assay device.

26. An assay reader according to claim 1 comprising circuitry to provide a fixed current from said battery.

27. An assay reader according to claim 1, wherein the reader and the assay device are separable.

28. An assay reader according to claim 1, wherein the reader and the assay device are non-separable.

29. An assay reader according to claim 1, comprising a control indicator to indicate sufficient battery power to generate the excitation signal.

30. An assay reader according to claim 29, wherein said control indicator is an LED indicator on an outer surface of said reader.

31. An assay reader according to claim 29, wherein said control indicator is an electro-chromic or thermo-chromic indicator on an outer surface of said reader.

32. An assay reader according to claim 29, wherein said control indicator is a fluorescent dye, which produces a control emission signal in response to the excitation signal.

33. An assay reader according to claim 1, wherein the assay device is lateral flow immunoassay device/

34. An assay reader according to claim 1, wherein the assay device is a homogenous assay device.

35. An assay apparatus comprising an assay reader according to claim 1, and one or more assay devices.

36. An assay apparatus according to claim 35, wherein said one or more assay devices comprise a capture zone and one or more luminescent labels.

37. A method of determining the presence of a luminescent label in the capture zone of an assay device comprising:
exciting said label with an excitation signal of a first wavelength such that the excited label produces an emission signal of a second wavelength; and
visually observing the emission signal.

38. A method according to claim 37 comprising filtering said excitation signal from said emission signal prior to observing said emission signal.

39. A method according to claim 37, wherein the label is selected from the group consisting of a fluorescent label immobilised in a polysterene microsphere, a quantum dot and an up-converting phosphor containing ceramic microsphere.

40. A method of determining the presence of an analyte in a sample comprising:
providing an assay device which comprises a luminescent label and a capture zone;
contacting said device with a sample suspected of containing an analyte; such that the amount of label captured in the capture zone is altered in the presence relative to the absence of analyte in the sample;
exciting label captured in said capture zone with an excitation signal of a first wavelength such that the excited label produces an emission signal of a second wavelength; and
visually observing the emission signal.
